(19) United States
(12) Patent Application Publication
(10) Pub. No.: US 2006/0211877 A1
(43) Pub. Date: Sep. 21, 2006

(54) Preparation of tri(chloropropyl) phosphate

(76) Inventors: Thomas Weiss, Mannheim (DE); Wolfgang Grape, Koln (DE); Rainer Elbert, Bergisch Gladbach (DE); Jan-Gerd Hansel, Koln (DE); Johannes Kaulen, Odenthal (DE)

Correspondence Address: LANXESS CORPORATION, 111 RIDC PARK WEST DRIVE, PITTSBURGH, PA, 15275-1112, US

(21) Appl. No.: 11/375,938

(22) Filed: Mar. 15, 2006

(30) Foreign Application Priority Data
Mar. 18, 2005 (DE) 10 2005 012 595.6

(51) Int. Cl. C07F 9/02

(52) U.S. Cl. 558/106

(57) ABSTRACT

The invention describes a process for preparing tri(chloropropyl) phosphate (TCPP) using heterogeneous catalysts based on metal oxides.

The invention relates to a process for preparing tri(chloropropyl) phosphate (TCPP) by means of heterogeneous catalysis, the product being useful as a flame retardant in polyurethanes.

The preparation of tri(chloropropyl) phosphate (TCPP) is known to the skilled worker. Phosphorus oxychloride is used and is reacted with propylene oxide. To increase the reaction rate, catalysts are frequently employed. For homogeneously operating catalysts the skilled worker is aware of numerous versions.

Generally, however, it is necessary to purify the resulting mixtures from configurational isomers of TCPP, namely (MeCHClCH₂O)₃PO, (ClCH₂CH₂CH₂O)₃PO, (ClCH₂CH₂CH₂O)(MeCHClCH₂O)_{2 -}PO, (ClCH₂CH₂CH₂O)₂(MeCHClCH₂O)PO) in complex systems which operate with homogeneous catalysis. Aftertreatment is usually accomplished by an aqueous workup of the crude reaction products, in the course of which the catalyst is destroyed irreversibly and separated off.

### BACKGROUND ART

This is described for example in DD 125 035, the deactivation and destruction of the titanium halide catalyst being achieved by adding a stoichiometric amount of water or by washing the phosphorus-containing alkoxylation products with water or alkalis.

Aftertreatments of this kind for destroying or deactivating the catalyst, however, have disadvantages. They additionally necessitate reactors, there is a deterioration in the space-time yield and product losses occur. Finally, the wash waters produced must be disposed of, which is costly and inconvenient, and the catalyst employed is lost to further use.

The use of heterogeneous catalysts in the synthesis of TCPP has not hitherto been disclosed.

A continuous production method for 2-haloalkylated phosphates is described by CN 1034206. That method uses BeO. The process allows the preparation of low-acid products (acid number<0.2 mgKOH/g substance) such as (MeCHClCH₂O)₃PO, (ClCH₂CHClCH₂O)₃PO, and (ClCH₂CH₂O)₃PO. A disadvantage associated with the use of the catalyst is the potential release of highly toxic beryllium salts.

U.S. Pat. No. 3,557,260 proposes the use of sulfates of various elements. The required reaction time is approximately 80 hours, the process lasting much longer in comparison to the prior art for economic operations.

The object was therefore to develop a process for preparing TCPP using heterogeneous catalysts.

### SUMMARY OF THE INVENTION

The achievement of the object, and subject-matter of the present invention, is a process for preparing low-acid TCPP by reacting phosphorus oxychloride with propylene oxides without additional water or alkali washes of the phosphorus-containing alkoxylation products, which comprises using heterogeneous metal oxide catalysts of the formula (I)
[(X)₁³⁺(B)ₙ^{b+}]Oₘ(I)
wherein
X is aluminum, titanium or zirconium,
B is a metal or nonmetal from the group Li, Na, K, Mg, Ca, Sr, Ba, Sc, Y, Ln, Ti, Zr, Hf. V, Nb, Ta, Cr, Mo, W, B, Ga, In, Si, Ge, Sn, Pb, P, As, Sb, and Bi,
b is the valence of the metal or nonmetal B and is an integer from 1 to 6,
l, n, and m are numerical variables to be selected independently from the numbers 0.0001 to 4.0000 and subject to the following condition:
2·m=1·3+n·b.
The mixed oxides here are to be interpreted not only as stoichiometric combinations but also as combinations of nonstoichiometric compositions. This is what the symbol “*” is intended to express. In particular it is also possible for combinations of metal oxides of one and the same element in different oxidation states to find use.

Surprisingly, the use of heterogeneous metal oxide catalysts of the formula (I) enables water-free separation of the catalyst from the reactants and reaction products. This ease of separation therefore makes it possible to do without costly and inconvenient product washing, and to make the production operation more economic as compared with the prior art. In addition, the formation of acidic by-products is suppressed, as is evident from the extremely low acid numbers of the TCPP obtained in accordance with the invention. Furthermore, in a batchwise procedure, the catalyst employed can be used again.

These heterogeneous catalysts are distinguished preferably by a substantial insolubility in the reaction medium and can be removed from the reaction medium by simple, nonaqueous methods—for example, by simple filtration methods or by utilizing centrifugal forces.

### DETAILED DESCRIPTION OF THE PREFERRED EMBODIMENTS

In one preferred embodiment of the present invention the (mixed) metal oxides to be used as heterogeneous catalysts are oxides of the transition group elements of the periodic table, more preferably oxides of the metals of groups 13-15 of the Periodic Table of the Elements. In this context the term “Periodic Table of the Elements” understood below is that according to IUPAC (Nomenclature of Inorganic Chemistry 1989). Very particular preference is given to the (mixed) metal oxides of groups 3-6, 13, and 14 of the Periodic Table of the Elements.

Inventively preferred for B are the ions of the following elements: Na, K, Mg, Ca, Sc, Y, Ti, Zr, W, Si, Sn

Especially preferred, simple oxides are: ZrO₂, TiO₂, Al₂O₃

Mixed oxides whose use is preferred are:

SiO₂*Al₂O₃, SnO₂*Al₂O₃, TiO₂*Al₂O₃, ZrO₂*Al₂O₃, WO₃*Al₂O₃, Sc₂O₃*Al₂O₃, Y₂O₃*Al₂O₃, Na₂O*Al₂O₃, K₂O*Al₂O₃, MgO*Al₂O₃, CaO*Al₂O₃.

SiO₂*TiO₂, SnO₂*TiO₂, TiO₂*ZrO₂, WO₃*TiO₂, SC₂O₃*TiO₂, Y₂O₃*TiO₂, Na₂O*TiO₂, K₂O*TiO₂, MgO*TiO₂, CaO*TiO₂.

SiO₂*ZrO₂, SnO₂*ZrO₂, Al₂O₃*ZrO₂, , WO₃*ZrO₂, Sc₂O₃*ZrO₂, Y₂O₃*ZrO₂, Na₂O*ZrO₂, K₂O*ZrO₂, MgO*ZrO₂, CaO*ZrO₂.

TiO₂*Al₂O₃*ZrO₂, TiO₂*Al₂O₃*SiO₂, TiO₂*ZrO₂*SiO₂.

In a further preferred version of the process of the invention the heterogeneous catalysts to be used are composed of mixed metal oxides and/or metal nonmetal oxides and may additionally have been modified by further chemical operations. Examples of such modifications are sulfation, hydration or calcination. In this way, for example, sulfated ZrO₂, or ZrO₂*H₂O, is accessible.

On the one hand, physically prepared mixtures of metal oxides, prepared by trituration or grinding, for example, may be employed as heterogeneous catalysts in the preparation of TCPP. Also possible on the other hand is the use of heterogeneous catalysts obtained by means of sol/gel processes.

The heterogeneous metal oxide catalysts for use in accordance with the invention are suitable not only for the batchwise synthesis of TCPP but also for the continuous synthesis of TCPP.

In the batchwise procedure the heterogeneous catalyst is added prior to the reaction of phosphorus oxychloride with propylene oxide or in two or more portions before and during the reaction. The reaction is carried out at temperatures of 0 to 100° C. and at atmospheric pressure or under a slight overpressure of up to 1 MPa. Typically the reaction temperatures are between 50 to 80° C. The phosphorus-containing starting substance is charged to the reaction vessel and, following addition of catalyst, the alkylene oxide in question is metered in continuously. After the end of metering of propylene oxide an afterreaction phase is added, at temperatures of 60 to 130° C., and, finally, volatile impurities are removed by vacuum distillation and/or nitrogen stripping at temperatures of 90 to 150° C. and pressures of down to <0.05 MPa. Typically the removal of volatile constituents takes place at 130° C. and 40 mbar. There is no need for catalyst aftertreatment. In batchwise TCPP preparation processes the catalysts are employed in an amount of 0.02% by weight to 10% by weight, based on the phosphorus compound employed, and are added to the phosphorus-containing starting substance.

It is also possible, alternatively, to operate the synthesis of TCPP in a continuous operation, using, for example, fluid bed reactors or tube reactors. In this case the heterogeneous catalyst is the stationary phase and the reaction medium is the mobile phase. The reaction conditions are similar to those described for the batchwise regime.

Through the use of heterogeneous metal oxide catalysts a TCPP mixture is obtained, preferably, that comprises the isomers of formulae (II) to (V) 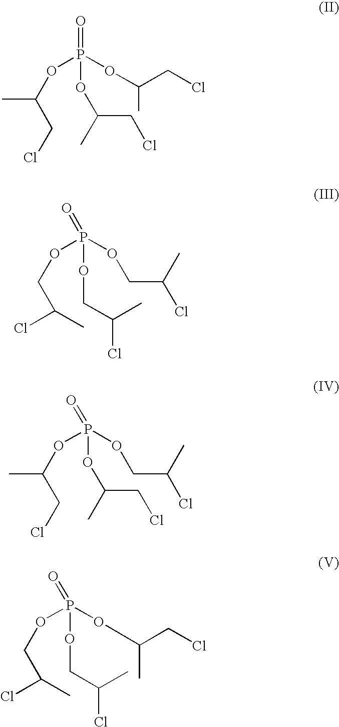
the ratio of isomers (II)/(III) in the mixture being preferably>2, more preferably>10, in particular >50, very preferably between 100 and 1,000.

### EXAMPLES

### Example 1

6 g of Al₂O₃ are weighed out together with POCl₃ (76.8 g, 0.5 mol) into a flask and the mixture is left to stand overnight under reduced pressure. The amount of POCl₃ is subsequently checked and supplemented. Then TCPP (100 g, 0.3 mol) is added and propylene oxide (102 g, 1.75 mol) is metered in over the course of 4 h. This is followed by stirring at 45° C. for 2 h.

Yield of TCPP prepared: 158 g, 96% of theory relative to POCl₃

By means of GC analysis, with a conversion rate of 100%, it is possible to calculate the composition of the TCPP formed in the final TCPP mixture:

Composition [GC-area%]:

(MeCHClCH₂O)₃PO: 79.2

(ClCH₂CH₂CH₂O)₃PO: 0.04

(ClCH₂CH₂CH₂O)(MeCHClCH₂O)₂PO: 16.6

(ClCH₂CH₂CH₂O)₂(MeCHClCH₂O)PO: 1.1

TCPP ether: 0.8

### Example 2

| | | ³¹P NMR | Residual | | | OP | OP | | | AN | AAS |
|---|---|---|---|---|---|---|---|---|---|---|---|
| | T_{R} | [mol % TCPP] | PO [GC | OP | OP | (Oiso) | (Oiso) | TCPP | | mg KOH/g | [ppm |
| Catalyst | [° C.] | 0 to −5.5 ppm | area %] | (Oiso)3 | (On)3 | 2(On) | (On)2 | ether | 2-MP | sample | metal] |
| TiCl₄ not inventive | 65 | | 0.01 | 66.3 | 0.2 | 25.6 | 3.7 | 2.9 | 0.1 | | |
| TIO₂ (RO13) | 55 | 71.3 | 0.34 | 39.6 | 4.5 | 23.8 | 0.4 | 7.6 | 0.0 | 4.27 | |
| TIO₂ (RO13) | 75 | 82.3 | 1.98 | 37.5 | 6.9 | 27.6 | 0.7 | 7.5 | 0.0 | 7.1 | 62 |
| ZrO₂ (RO130) | 45 | 43.3 | 0.31 | 12.4 | 2.4 | 14.7 | 6.6 | 7.2 | 0.0 | 35.7 | |
| ZrO₂ (RO130) | 75 | 72.1 | 1.90 | 20.9 | 1.2 | 20.9 | 8.2 | 12.3 | 0.0 | | 91 |
| SiO₂Al₂O₃ (GO202) | 75 | 97.1 | 2.92 | 48.2 | 0.8 | 31.7 | 8.4 | 3.1 | 0.0 | 8.9 | <1 |
| ZR(OZ)₂WO₃ (RO129) | 55 | 14.5 | 4.73 | 14.8 | 1.6 | 13.8 | 5.0 | 5.7 | 0.0 | | |
| Al₂O₃ (CSS 350) | 75 | 98.2 | 4.84 | 50.0 | 0.5 | 29.7 | 6.3 | 3.3 | 0.0 | <1.0 | 18 |
| Al₂O₃ (CSS 350)MgO | 75 | 96.3 | 6.21 | 51.7 | 0.5 | 23.9 | 5.2 | 2.5 | 0.0 | <1.0 | |

General operating instructions:

5 g of POCl₃ are introduced as an initial charge and the catalyst (1 g) is added. The mixture is then heated to 50° C. and, by means of a Telab pump model BF 411/30 (pump setting STROKE=30; delivery=50%=about 0.5 ml/min), a mixture of 11.7 g (7 ml) of POCl₃ and 20.9 g (25.1 ml) of propylene oxide is added dropwise. During the addition the temperature is maintained at between 40 and 50° C. (60 and 70° C.) by water bath cooling. After the end of the addition (GC/NMR) there is a subsequent stirring period of 180 minutes at 50° C. (70° C.) with subsequent analysis by means of GC and ³¹P NMR, acid number determination, and metal content by atomic absorption spectroscopy.

What is claimed is:

1. A process for preparing low-acid TCPP by reacting phosphorus oxychloride with propylene oxides without additional water or alkali washes of the phosphorus-containing alkoxylation products, which comprises using heterogeneous metal oxide catalysts of the formula (I)
[(X)₁³⁺(B)^{b+}]Oₘ(I)
wherein
X is aluminum, titanium or zirconium,
B is a metal or nonmetal from the group Li, Na, K, Mg, Ca, Sr, Ba, Sc, Y, Ln, Ti, Zr, Hf, V, Nb, Ta, Cr, Mo, W, B, Ga, In, Si, Ge, Sn, Pb, P, As, Sb, and Bi,
b is the valence of the metal or nonmetal B and is an integer from 1 to 6,
l, n, and m are numerical variables to be selected independently from the numbers 0.0001 to 4.0000 and subject to the following condition:
2m=1·3+n·b.

2. A process as claimed in claim 1, wherein mixtures of different oxides or mixed oxides are used as catalysts.

3. A process as claimed in claim 1, wherein TiO₂, ZrO₂, Al₂O₃ or SiO₂*Al₂O₃ are used as catalysts.

4. A process as claimed in claim 1, operated batchwise or continuously.

5. A process as claimed in claim 1, giving an isomer mixture of compounds (II) to (V) 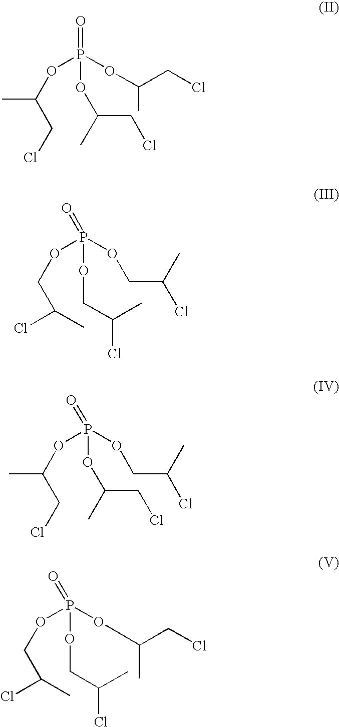
and the ratio of isomers (II)/(III) in the mixture being >2.
